(19) United States
(12) Patent Application Publication
(10) Pub. No.: US 2023/0295012 A1
(43) Pub. Date: Sep. 21, 2023

(54) APPLICATIONS OF HUMIC ACID IN IMPROVING PHYTOREMEDIATION EFFICIENCY OF HEAVY METALS IN WATERBODY

(71) Applicants: Fudan University, Shanghai (CN); Fuhuan Qingyun Technology (Zhejiang) Co., Ltd, Shaoxing (CN)

(72) Inventors: Zheng Zheng, Shanghai (CN); Suzhen Huang, Shanghai (CN); Zhikai Wang, Shanghai (CN); Qixuan Song, Shanghai (CN); Xingzhang Luo, Shanghai (CN); Xuhui Huang, Shanghai (CN); Yican Chen, Shanghai (CN); Haiqing Huang, Shanghai (CN)

(21) Appl. No.: 18/094,664

(22) Filed: Jan. 9, 2023

(30) Foreign Application Priority Data
Mar. 15, 2022 (CN) 202210254262.5

(51) Int. Cl. C02F 1/28; C02F 1/62; C02F 1/68

(52) U.S. Cl. CPC C02F 1/286; C02F 1/62; C02F 1/68; C02F 2101/20

(57) ABSTRACT

Disclosed are applications of humic acid (HA) in improving phytoremediation efficiency of heavy metals in waterbody, relating to the technical field of environmental ecological engineering. The phytoremediation of heavy metals is achieved by reducing heavy metals content in the waterbody by planting Vallisneria natans. HA is added to slow down the degreening of Vallisneria natans leaves under heavy metal toxicity, and to increase the accumulation of leaves and roots of Vallisneria natans to heavy metals, together with reducing the leaching capacity of heavy metals in waterbody; HA enhances the activity of enzymes related to reactive oxygen metabolism in plants by stimulating the synthesis of proteins and enzymes in various organs of plants, as well as reducing the concentration of malondialdehyde in plants, regulating the reactive oxygen content in plants, reducing the peroxidation of membrane lipids, and enhancing the resistance of plants to heavy metals.

### CROSS-REFERENCE TO RELATED APPLICATIONS

This application claims priority to Chinese Patent Application No. 202210254262.5, filed on Mar. 15, 2022, the contents of which are hereby incorporated by reference.

### TECHNICAL FIELD

The present application relates to the technical field of environmental ecological engineering, and in particular to application of humic acid in improving phytoremediation efficiency of heavy metals in waterbody.

### BACKGROUND

Phytoremediation, involving removing pollutants from waterbody or soil using plants, is one of the most used bioremediation methods for heavy metals; it is often used to selectively remove heavy metals of low concentrations with the advantages of high efficiency, environmental friendliness, low costs and no secondary pollution. As a representative of phytoremediation of waterbody, submerged plants not only maintain the diversity of aquatic species and functions, but also have a significant purifying effect on waterbody and bring about considerable ecological functions. Vallisneria natans is a typical submerged plant with no upright stems and ribbon shaped leaves. It has been considered as an important vegetation for aquatic ecosystem reconstruction because of its strong environmental adaptability, restoration ability and water purification functions, and is especially effective in terms of heavy metal tolerance and enrichment compared to other types of aquatic plants. However, heavy metals in higher concentrations have a greater acute toxic effect on submerged plants, causing irreversible damage to plant cells and thus affecting phytoremediation, so it is particularly important to improve plant enrichment efficiency and plant tolerance to heavy metals.

In recent years, natural organic acids found in humus, widely recognized as a natural chelating agent with humic acid (HA) as the main component, have attracted a lot of attention from researchers. The large number of functional groups contained in HA have various properties such as carboxyl, phenolic hydroxyl, alcohol hydroxyl, carbonyl, etc., and the functional groups enable HA to modify the morphology and biological effectiveness of heavy metals. Most of the current studies address the effect of HA on soil plants, with the suggestion that HA can interact directly with soil components to modify soil properties, thus affecting the morphology of heavy metals and their biological effectiveness, as well as interact with heavy metals through non-specific and specific adsorption and precipitation in addition to complexation, thus influencing the retention capacity of heavy metals in soil and their mobility. For aquatic plants, there are relatively few applications of HA for heavy metal remediation in waterbody, and it is still much controversial for the role of HA on the differences caused by plant and heavy metal species.

### SUMMARY

It is an objective of the present application to provide applications of humic acid (HA) in improving phytoremediation efficiency of heavy metals in waterbody, so as to solve the problems of the prior art described above.

To achieve the above objective, the present application provides following technical schemes:
applications of HA in improving the phytoremediation efficiency of heavy metals in waterbody, where the phytoremediation of heavy metals includes reducing heavy metals in terms of content in the waterbody by planting Vallisneria natans.

Optionally, the applications include alleviating degreening phenomenon of Vallisneria natans leaves under heavy metal toxicity.

Optionally, the applications include increasing accumulation of heavy metals in the leaves and roots of Vallisneria natans.

Optionally, the applications include reducing leaching capacity of heavy metals in waterbody.

Optionally, the applications include improving the Vallisneria natans in terms of resistance to heavy metals.

The present application also provides a method of using HA to improve remediation efficiency of Vallisneria natans against heavy metals in waterbody, where the HA is added into the waterbody in a concentration of 0.5-2 milliliters per liter (mg·L⁻¹).

The present application discloses the following technical effects:
according to the research of the present application, HA is added to slow down the degreening of Vallisneria natans leaves under heavy metal toxicity, and to increase the accumulation of leaves and roots of Vallisneria natans plants to heavy metals, together with reducing the leaching capacity of heavy metals in waterbody; it enhances the activity of enzymes related to reactive oxygen metabolism in plants by stimulating the synthesis of proteins and enzymes in various organs of plants, as well as reducing the concentration of malondialdehyde (MDA) in plants, regulating the reactive oxygen content in plants, reducing the peroxidation of membrane lipids, and enhancing the resistance of plants to heavy metals.

### BRIEF DESCRIPTION OF THE DRAWINGS

For a clearer description of the technical schemes in the embodiments or prior art of the present application, the following drawings are briefly described for use in the embodiments, and it is obvious that the drawings in the following description are only some embodiments of the present application, and that other drawings may be obtained on the basis of these drawings without any creative effort on the part of a person of ordinary skill in the art.

FIG. 1 shows a schematic diagram of a device to study an effect of humic acid (HA) on Vallisneria natans and biofilm under heavy metal stress.

FIG. 2 illustrates growth of Vallisneria natans under different conditions on day 0, day 10 and day 20.

FIG. 3 shows changes in terms of increase of fresh weight of Vallisneria natans in each group, where different letters (a-c) indicate significant differences (P<0.05).

FIG. 4A-FIG. 4B show changes in total chlorophyll and Fv/Fm values for each group of Vallisneria natans, where FIG. 4A is the change in total chlorophyll and FIG. 4B is the change in Fv/Fm values.

FIG. 5A-FIG. 5B show changes of Pb²⁺ and Cd²⁺ concentrations in waterbody, where FIG. 5A is the change of Pb²⁺ concentration and FIG. 5B is the change of Cd²⁺ concentration.

FIG. 6A-FIG. 6B show changes of Pb²⁺ and Cd²⁺ concentrations in leaves and roots of Vallisneria natans, where (a) is the change of Pb²⁺ concentration and (b) is the change of Cd²⁺ concentration, and letters a-c indicate significant differences (P<0.05).

FIG. 7 shows a three-dimensional fluorescence spectrum of dissolved organic matter (DOM) in a water sample of group CT.

FIG. 8 shows a three-dimensional fluorescence spectrum of DOM in water sample of group HA1.

FIG. 9 shows a three-dimensional fluorescence spectrum of DOM in water sample of group HA2.

FIG. 10 is a three-dimensional fluorescence spectrum of DOM in water sample of group HA3.

FIG. 11 is a three-dimensional fluorescence spectrum of DOM in water sample of M group.

FIG. 12 shows a three-dimensional fluorescence spectrum of DOM in water sample of group HA1_Ms.

FIG. 13 shows a three-dimensional fluorescence spectrum of DOM in water sample of group HA2_M.

FIG. 14 is a three-dimensional fluorescence spectrum of DOM in water sample of group HA3_M.

FIG. 15A-FIG. 15B show changes of total protein (TPr) and metallothioneins (MTs) of Vallisneria natans leaves in each group, in which FIG. 15A is the change of TPr, FIG. 15B is the change of MTs, with letters a-c indicating significant differences (P<0.05).

FIG. 16A-FIG. 16B illustrates influences of HA on Superoxide dismutase (SOD) (a) and peroxidase (POD) (b) activities of Vallisneria natans under Pb and Cd stresses, and letters a-b represent significant differences (P<0.5).

FIG. 17 shows effects of HA on malondialdehyde (MDA) content of Pb and Cd-stressed Vallisneria natans, and letters a-e represent significant differences (P<0.5).

FIG. 18 shows effects of different concentrations of HA on the methylation level of Vallisneria natans leaves.

FIG. 19 shows effects of different concentrations of HA on DNA methylation levels of Vallisneria natans leaves under Pb and Cd stresses.

### DETAILED DESCRIPTION OF THE EMBODIMENTS

Various exemplary embodiments of the present application are now described in detail, and this detailed description should not be considered a limitation of the present application, but should be understood as a rather detailed description of certain aspects, features and embodiments of the application.

It is to be understood that the terms described in the present application are intended to describe particular embodiments only and are not intended to limit the present application. Further, for the range of values in the present application, it is to be understood that each intermediate value between the upper and lower limits of the range is also specifically disclosed. Each smaller range between any stated value or intermediate value within a stated range, and any other stated value or intermediate value within a stated range is also included in the present application. The upper and lower limits of these smaller ranges may be independently included or excluded from the scope.

Unless otherwise indicated, all technical and scientific terms used herein shall have the same meaning as commonly understood by those of ordinary skill in the art described herein. Although the present application describes only preferred methods and materials, any methods and materials similar or equivalent to those described herein may also be used in the implementation or testing of the present application. All literature referred to in this specification is incorporated by reference for the purpose of disclosing and describing the methods and/or materials associated with said literature. In the event of conflict with any incorporated literature, the contents of this specification shall prevail.

Without departing from the scope or spirit of the present application, various improvements and variations may be made to specific embodiments of the specification of the present application, as will be apparent to those skilled in the art. Other embodiments obtained from the specification of the present application will be apparent to the skilled person. The specification and embodiments of the present application are exemplary only.

As used in this application, the terms “including”, “comprising”, “having” and “containing” are all open terms, mean including but not limited to.

The present application uses submerged plant of Vallisneria natans obtained from Shanghai Yuetian Biotechnology Co., Ltd. (Shanghai, China). Before experiment, all obtained Vallisneria natans should be washed with tap water and put into a same incubator for 2 weeks for later use, with incubation temperature of 25±2 degree Celsius (° C.) and light: dark period of 12:12 hours (h).

### Embodiment 1

### I. Experimental Methods

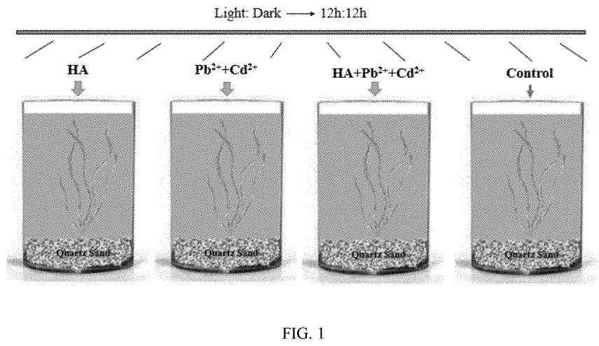

As shown in FIG. 1, 7 grams (g) of Vallisneria natans is transplanted into a 5 liters (L) plexiglass container (ADAaquAsoil, AquADesign Amano Company, Japan), 3 L of tap water is added into the container, and the roots of Vallisneria natans are inserted into 50 millimeters (mm) quartz sand. During the experiment, the Vallisneria natans is cultured under growth conditions of 25±2° C. and light: dark period of 12:12 h, with a light intensity of 80 micro moles per square meters per second (μmolm⁻²s⁻¹).

Pb²⁺, Cd²⁺ mixture of 1.0 micrograms per liter (mg·L⁻¹) and humic acid (HA) of different concentrations are added into the container; the experimental groups and the control group are respectively arranged with 3 parallels. The experimental grouping is arranged as shown in Table 1 with an experimental period of 20 days.

TABLE 1

| | Pd²⁺ and Cd²⁺ | HA |
|---|---|---|
| Grouping | concentrations (mg · L⁻¹) | concentration (mg · L⁻¹) |
| CT | 0 | 0 |
| HA1 | 0 | 0.5 |
| HA2 | 0 | 1.0 |
| HA3 | 0 | 2.0 |
| M | 1.0 + 1.0 | 0 |
| HA1_M | 1.0 + 1.0 | 0.5 |
| HA2_M | 1.0 + 1.0 | 1.0 |
| HA3_M | 1.0 + 1.0 | 2.0 |

### II. Main Testing Indicators and Characterization Methods

### 2.1 Determination of Main Water Quality Parameters

### (1) Total Nitrogen (TN) and Total Organic Carbon (TOC)

The concentrations of TN and TOC in the samples are measured by TOC-L analyzer.

Each water sample is required to be filtered through an aqueous membrane of 0.45 μnmol before being put on the analyzer, and each parallel sample is measured three times in repetition.

### (2) P (Total Phosphorus (TP) and Soluble Phosphate)

The concentration of TP in water is determined by potassium persulfate digestion ultraviolet spectrophotometric method, and the content of soluble phosphate in water samples is determined by molybdenum blue microplate method.

### (3) pH Value

A portable pH meter (YSI, USA) is used to measure the pH value, and the measurement is repeated 3 times for each parallel sample.

### 2.2 Measurement of Biomass and Photosynthesis Related Indicators

### (1) Fresh Weight (FW)

The FW of Vallisneria natans is determined by an analytical balance with water and impurities wiped off the leaves before weighing.

### (2) Total Chlorophyll Chl(a+b) Content

Vallisneria natans leaves of 0.2 g are washed and dried, then put into 10 milliliters (mL) of 96 percent (%) ethanol solution for dark extraction for 24 h, and their absorbance values are measured by spectrophotometer at 649 nanometers (nm) and 665 nm respectively. Total Chl(a+b) content is calculated as follows:

Cₐ=12.7A₆₆₃−2.69A₆₄₅

C_{b}=22.95A₆₄₅−4.68A₆₆₃

C=Cₐ+C_{b}.

### (3) Primary Light Energy Conversion Efficiency of PSII (Fv/Fm)

The leaves of Vallisneria natans in each group are cut about 3 centimeters (cm), and the Fv/Fm value is measured by hand-held chlorophyll fluorescence meter. Each sample is repeatedly measured for 3 times.

### 2.3 Detection of Heavy Metals

### (1) Plant Digestion

At the end of the experiment, the harvested leaves and roots of Vallisneria natans are dried and ground. A certain amount of powder of leaves and roots is weighed, and HNO₃ and HClO₄ are added in a certain proportion for digestion. The digested sample is filtered through a 0.45 micrometer (μM) water system membrane, and the volume is fixed before the experiment of analyzer.

### (2) Detection on the Analyzer

The concentrations of Pb and Cd are determined by an inductively coupled plasma mass spectrometry (ICP-MS). Both water samples and samples digested by plants need to be filtered by 0.45 μm water system membrane and then put on the computer.

### 2.4 Three-Dimensional Fluorescence Spectrum Detection

The water sample is filtered by the 0.45 μM water system membrane, and then the corresponding fluorescence spectrum of the sample is obtained by three-dimensional fluorescence spectrometer; the scanning ranges of excitation wavelength and emission wavelength are set to 240-800 nm and 250-800 nm, respectively, with a scanning speed of 1,000 nanometers per minutes (nm/min) and a slit width of 10 nm;

### 2.5 Determination of Protein and Related Enzyme Activities

### (1) Sample Pretreatment

At the end of the experiment, 1 g of Vallisneria natans leaves are collected, washed with deionized water and frozen in liquid nitrogen to prevent inactivation. The obtained leaves are ground with 0.1 mole (M) phosphate buffer saline (PBS) solution at 4° C. according to the weight (g): volume (mL) ratio of 1:9, centrifuged at 3,500 revolutions per minute (rpm) for 10 min, and the supernatant is taken and stored in an ultra-low temperature refrigerator at −80° C. for later use.

### (2) Determination of Related Enzyme Activities

Total protein (TPr), metallothioneins (MTs), superoxide dismutase (SOD), peroxidase (POD), catalase (CAT) and other activities are determined by using related kits. The specific operation steps are carried out according to the corresponding kit instructions.

### (3) Determination of Malondialdehyde (MDA) Concentration

The MDA concentration of Vallisneria natans leaves is determined using a related kit, with the principle of using thiobarbituric acid (TBA) to condense with MDA in peroxidized lipid degradation products, producing a red product with a maximum absorption peak at 523 nm.

2.6 Extraction and Determination of DNA from Plant Leaves

At the end of the experiment, all groups of Vallisneria natans leaves are collected and put into the ultra-low temperature refrigerator at −80° C. for later use. The DNA of each group of Vallisneria natans leaves is extracted using the HP Plant DNA Kit from the Omega Company, and the extraction is carried out according to the kit instructions.

### 2.7 Genome-Wide DNA Methylation Detection

Using a MethylFlash™ Global DNA Methylation (5-mC) ELISA Easy Kit, the above extracted sample DNA is used to detect the level of DNA cytosine methylation (5-mC) according to a formula of DNA methylation (5-mC) level as follows:

$$5 - mC \% = \frac{{( {b}^{2} + 4 aY )}^{0.5}}{2 a} \div S \times 100 \%$$

### 2.8 DNA Methylation Sensitive Amplification Polymorphism (MSAP)

The MSAP analysis experiment is performed, where the junction and primer sequences are shown in Table 2.

| Junction and | |
|---|---|
| primer name | Sequences |
| Eco-adaptor I | 5′-CTCGTAGACTGCGTACC-3′ |
| Eco-adaptor II | 5′-AATTGGTACGCAGTCTAC-3′ |
| H/M-adaptor I | 5′-GACGATGAGTCCTGAG-3′ |
| H/M-adaptor II | 5′-CGCTCAGGACTCAT-3′ |
| EOO | 5′-GACTGCGTACCAATTC-3′ |
| MSPOO | 5′-GATGAGTCCTGAGCGG-3′ |

Then, the amplified PCR products are denatured at 94° C. for 10 min, and then analyzed by vertical electrophoresis with 6% denatured polyacrylamide gel, followed by silver staining for subsequent band analysis.

### 2.9 Data Analysis

Primarily Origin 8.5 is used for plotting, and one-way analysis of variance (ANOVA, Analysis of Variance) is performed using SPSS 22.0 to compare the significant differences among the data groups. Among them, the bands of MSAP plots are counted with software Quantity One and converted into phenotypic data 0/1 matrix for subsequent statistical analysis.

### III. Experimental Results

3.1 Analysis of Growth and Photosynthesis Changes of Vallisneria natans

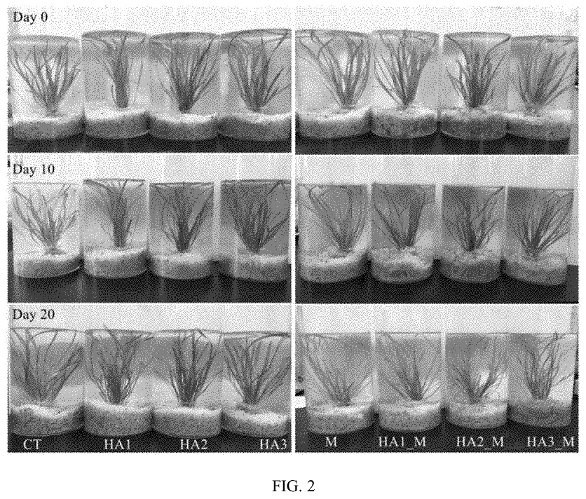

FIG. 2 shows the growth of Vallisneria natans under different conditions at day 0, day 10 and day 20. It is observed that the Vallisneria natans keeps growing more vigorously in the groups without exogenous heavy metals (CT, HA1, HA2, HA3 groups), indicating that the growth of Vallisneria natans is not significantly inhibited by the addition of HA; in the groups with exogenous heavy metals (M, HA1_M, HA2_M, and HA3_M groups), the yellowing of leaves is gradually severe from day 0 to day 20. At day 20, the number of degreened leaves of Vallisneria natans is relatively reduced and the chlorosis is alleviated with the increase of exogenous HA concentration as comparing to the M group; therefore, it can be inferred that HA serves to alleviate the degreening of Vallisneria natans leaves and the toxic effects of Pb and Cd heavy metals on Vallisneria natans.

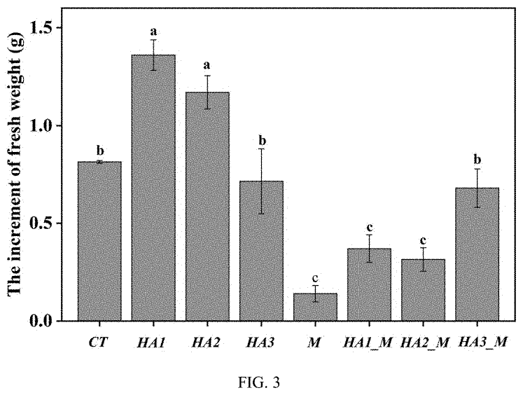

FIG. 3 shows the effect of HA at different concentrations on the increase of FW of Vallisneria natans in each group; in the group without exogenous heavy metal treatment, the increase of FW of Vallisneria natans tends to increase first and then decrease with the increase of HA concentration compared with the CT group, and that of both HA1 and HA2 groups are significantly higher than the CT group (P<0.05), indicating that the exogenous HA at certain concentrations may promote the growth of Vallisneria natans; in the group treated with exogenous heavy metals, the increase in FW of Vallisneria natans follows an increasing trend with the increase of HA concentration compared to the M group, suggesting that HA may alleviate the toxic effects of heavy metals on Vallisneria natans to some extent.

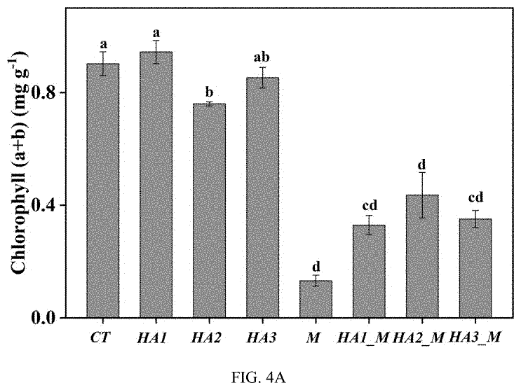

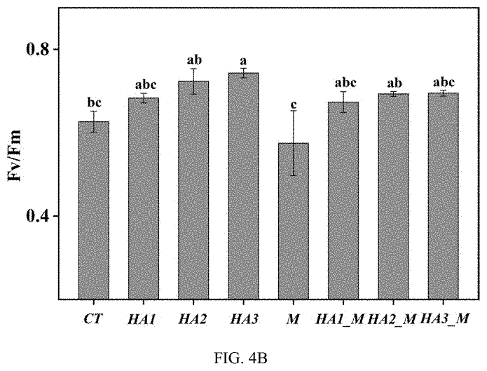

The effects of different concentrations of HA on photosynthesis of Vallisneria natans under each group of conditions are illustrated in FIG. 4A and FIG. 4B respectively, where the total chlorophyll content (Chl(a+b)) and Fv/Fm values of the leaves are measured; among them, Fv/Fm is an indicator of the occurrence of photoinhibition in the leaves, and a decrease in the value indicates a disruption of the photosynthetic system; from the figure, it can be seen that in the group without exogenous heavy metals treatment, the increase of Chl(a+b) content by simply adding different concentrations of HA is not significant compared with that of group CT, but with the increase of HA concentration, the Fv/Fm values of HA1, HA2 and HA3 groups show a rising trend, indicating that the moderate amount of HA has a promoting effect on photosynthesis of plants; the values of Chl(a+b) content and Fv/Fm of Vallisneria natans are significantly lower in the M group compared to that of the CT group (P<0.5), indicating that heavy metals disrupt the photosynthetic system of plants; in the groups treated with exogenous heavy metals, the Chl(a+b) content of Vallisneria natans shows a tendency to increase and then decrease as the concentration of exogenous HA increases compared to the M group, but always higher than the Chl(a+b) content of the M group; additionally, there is a significant increase in Fv/Fm values (P>0.5). In summary, the results suggest that a certain concentration of HA has a mitigating effect of reducing chloroplast damage caused by heavy metals; and the chlorophyll is increased and then decreased under the influence of the higher concentration of HA on the metabolism of the carbohydrate enzymes involved, which may lead to a decrease in chlorophyll content.

### 3.2 Changes of Heavy Metal Content in Water and Plant Tissues

### 3.2.1 Changes of Pb and Cd Concentrations in Waterbody

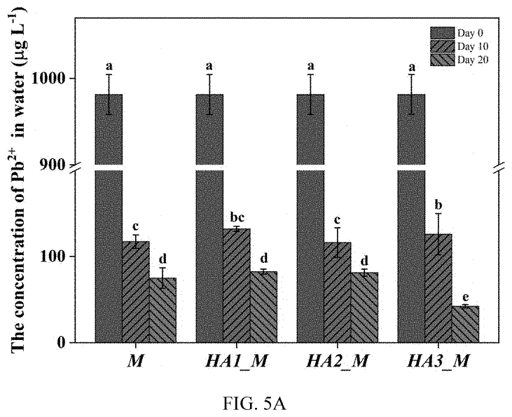

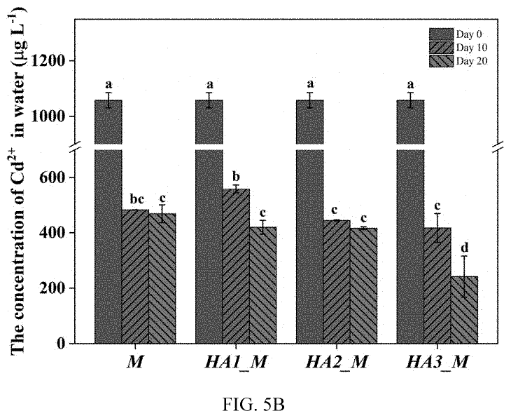

The changes in the concentrations of heavy metals Pb²⁺ (FIG. 5A) and Cd²⁺ (FIG. 5B) in the waterbody at day 0, day 10 and day 20 for each group are illustrated in FIGS. 5A-5B; from the figures, it can be seen that in the groups treated with exogenous heavy metals, the concentrations of heavy metals Pb²⁺ and Cd²⁺ are significantly reduced at day 10 and day 20 (P<0.05), indicating that the reduction of heavy metal concentrations in the waterbody is attributed to the absorption and enrichment of heavy metals by Vallisneria natans. At day 20, the concentrations of both Pb²⁺ and Cd²⁺ in the waterbody in comparison with M group show a decreasing trend with increasing HA concentration, from which it can be inferred that the leaching capacity of heavy metals in the waterbody is reduced by adding HA.

3.2.2 Changes of Pb and Cd Concentrations in Leaves and Roots of Vallisneria natans

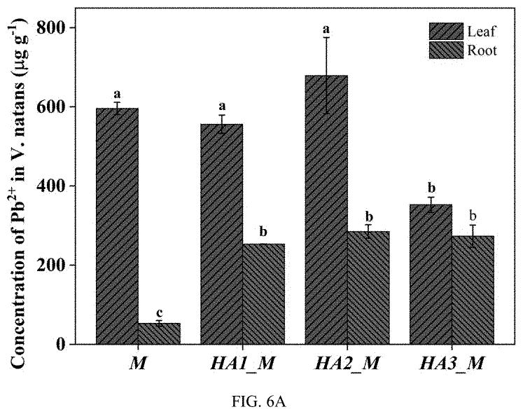

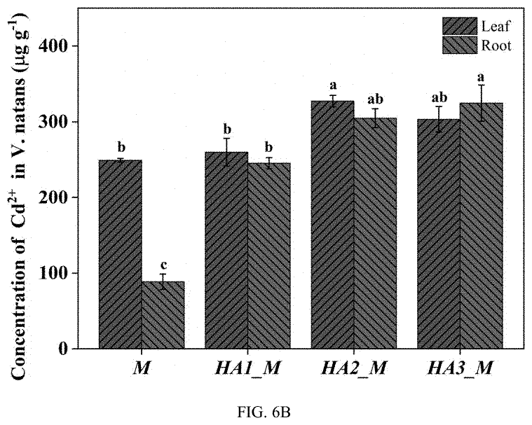

To further investigate the effect of HA on the uptake of heavy metals enrichment by Vallisneria natans, the contents of Pb²⁺ and Cd²⁺ in the leaves and roots of Vallisneria natans are measured as shown in FIG. 6A-FIG. 6B. Evidently the concentrations of Pb²⁺ and Cd²⁺ in the leaves of Vallisneria natans show a trend of increasing and then decreasing with the increase of exogenous HA concentration in the group treated with exogenous heavy metals compared with the M group, and the content of Pb²⁺ in the leaves of Vallisneria natans is significantly decreased especially (HA3_M group), indicating that HA of appropriate concentration promotes the uptake of heavy metals in Vallisneria natans leaves, and for different kinds of heavy metals, the effect of HA on plant accumulation is different. Furthermore, the concentrations of Pb²⁺ and Cd²⁺ in the roots of Vallisneria natans are significantly higher (P<0.05) with the increase of exogenous HA concentration and both are higher than those in the M group, suggesting that exogenous HA can significantly increase the accumulation of heavy metals Pb²⁺ and Cd²⁺ by the roots of Vallisneria natans. It is analyzed that, on one hand, the interaction of HA with organic acids secreted by plant roots and inter-root microbial activities breaks down HA into small molecular units that are easily absorbed by plants, thus promoting the uptake of HA complexes with heavy metals by plants; on the other hand, HA increases the ductility of plant cell walls, thus promoting the accumulation and transport of Pb²⁺ and Cd²⁺.

### 3.3 Three-Dimensional Fluorescence

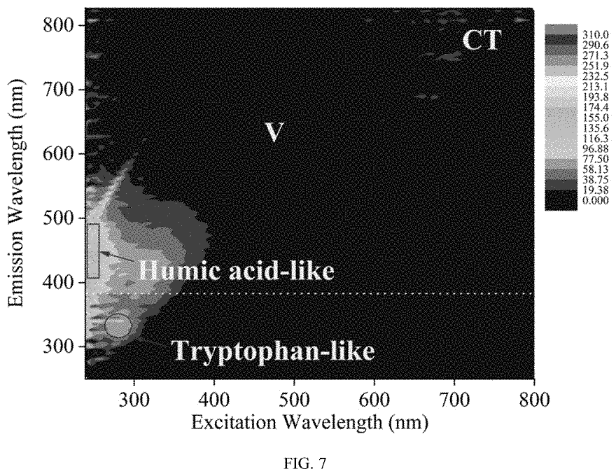

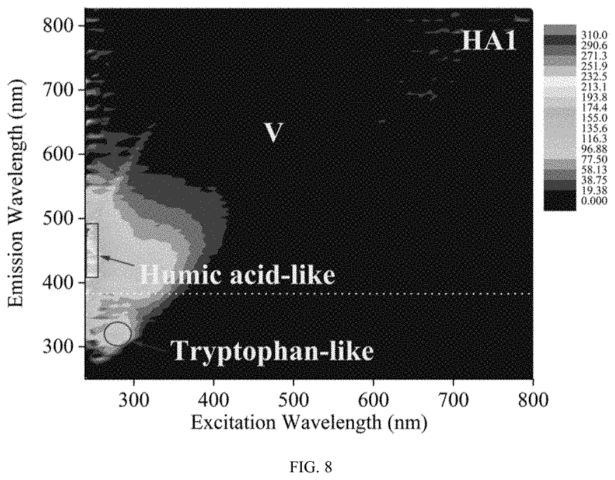

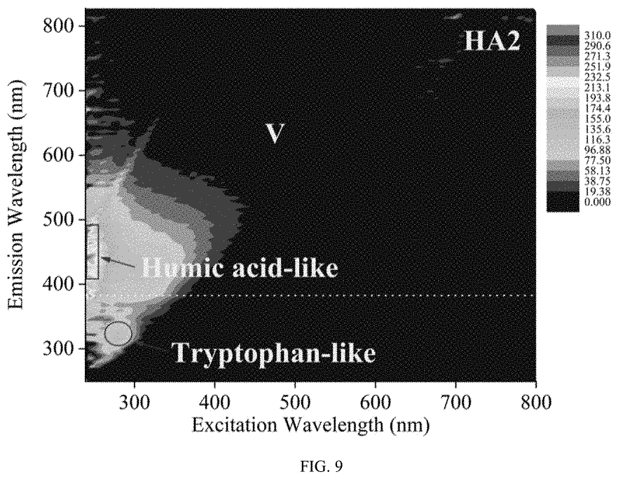

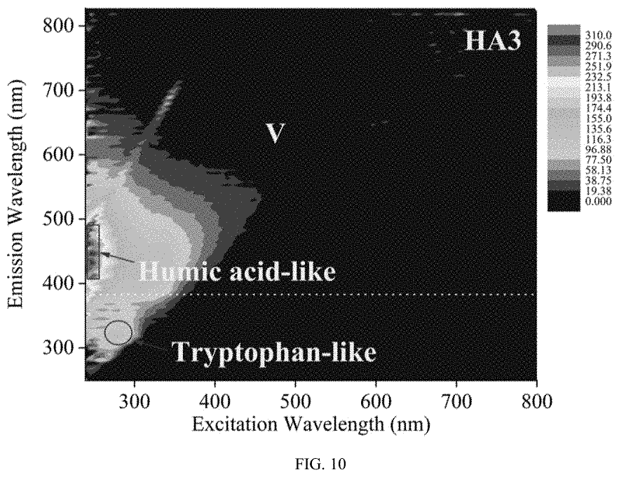

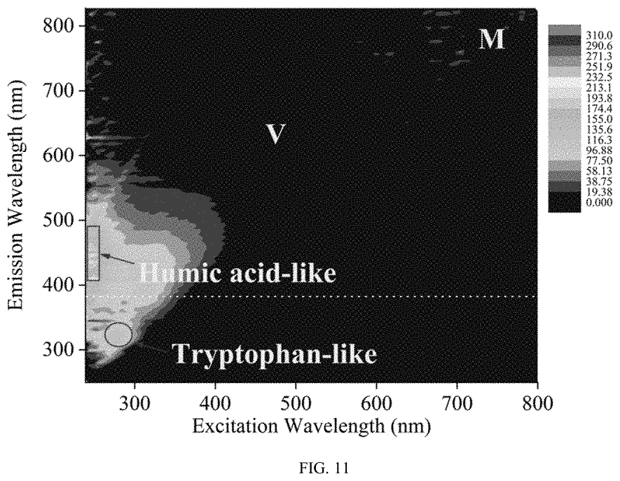

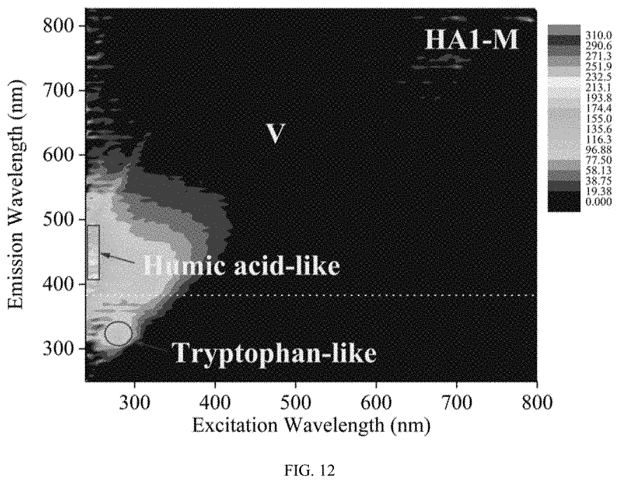

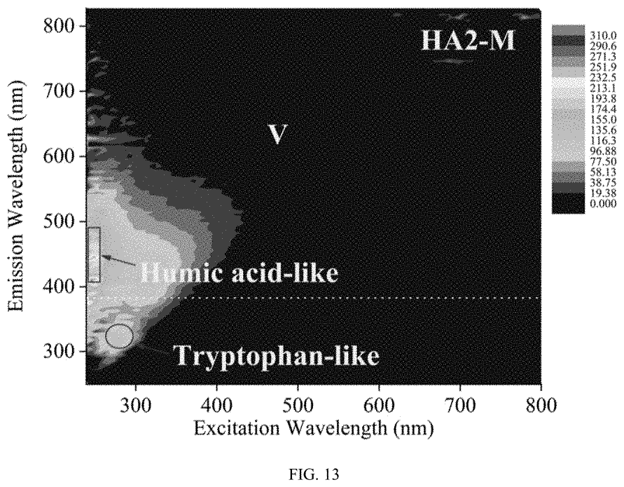

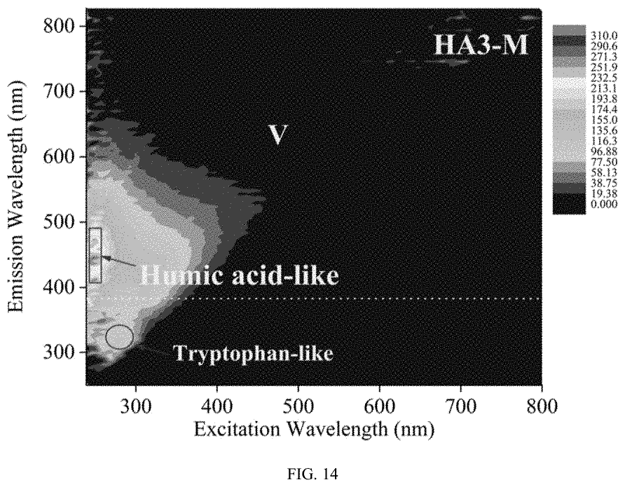

FIGS. 7-14 show the three-dimensional fluorescence spectra of the water samples of each group obtained at the end of the experiment, where the fluorescent group peaks in V are the regions in DOM where HA-like substances are located. Compared with the CT group, the fluorescence intensity of the region where the HA-like group is located keeps increasing with the increase of HA concentration, indicating that the residual HA concentration in the waterbody increases with the increase of the injected HA concentration, and HA is difficult to be degraded in the waterbody. In contrast, the fluorescence intensity is relatively decreased in the HA1-M group compared with the HA1 group, as well as in the HA2-M group compared with the HA2 group and the HA3-M group compared with the HA3 group. This result suggests that HA in the waterbody may have undergone a complexation reaction with heavy metals; moreover, the enhancement of fluorescence is observed at the Ex/Em=270/330 nm position in other groups in comparison with the CT group; it is proposed that this region is a dissolved microbial metabolite produced by microbial and bacterial degradation processes, and it has been suggested that the tryptophan-like fraction is closely related to the bacterial community activity, which is particularly sensitive to environmental changes.

### 3.4 Changes in Protein

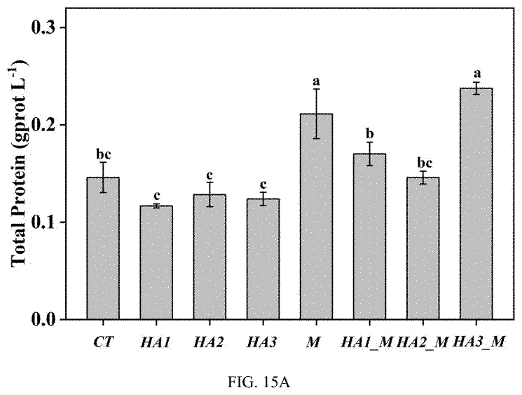

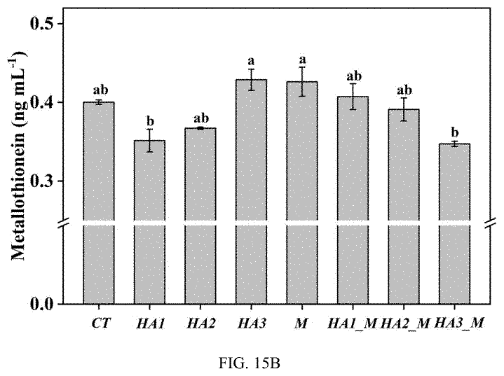

As shown in FIGS. 15A-FIG. 15B, in the groups without exogenous heavy metal treatment, the concentrations of TPr and MTs show no significant changes with the increase of the added HA concentration compared to the CT group (P<0.5), indicating that the addition of HA alone does not cause changes in protein synthesis in Vallisneria natans. The TPr and MTs concentrations of Vallisneria natans leaves in the M group are all increased comparing with the CT group (P<0.5), suggesting that Vallisneria natans resists heavy metal stress by increasing protein synthesis when it is subjected to heavy metal stress. In the groups treated with exogenous heavy metals, the TPr concentration of Vallisneria natans leaves shows a trend of decreasing and then increasing with the increase of applied HA concentration compared with the M group, while the MTs concentration gradually decreases with the increase of HA concentration. Therefore, it can be inferred that HA can enhance the resistance of plants to heavy metals by regulating the synthesis of proteins in various organs of plants under the stresses of heavy metals and other adversities.

### 3.5 Changes of Antioxidant Enzyme System and MDA Concentration

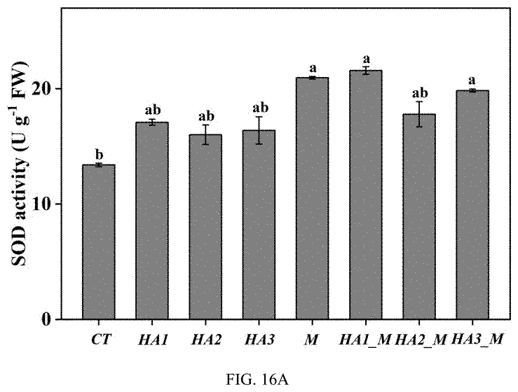

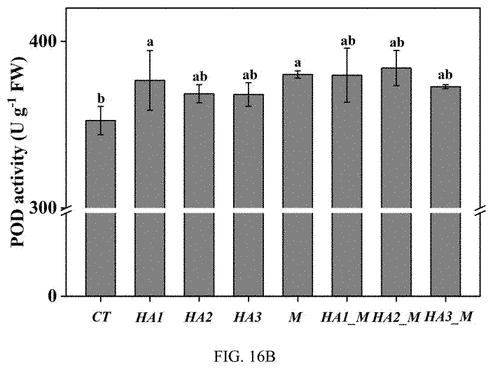

As shown in FIG. 16A-FIG. 16B, both SOD and POD are increased in the HA group compared to the CT group in the groups without exogenous heavy metals treatment, indicating that HA can enhance the antioxidant enzyme activity of Vallisneria natans. In the groups without exogenous heavy metals treatment, both SOD and POD activities are increased compared with that of the M group, indicating that HA can stimulate the synthesis of Vallisneria natans enzymes and enhance SOD and POD activities to scavenge the free radicals produced by heavy metal stress in Vallisneria natans under Pb and Cd stresses, thus reducing the toxic effects.

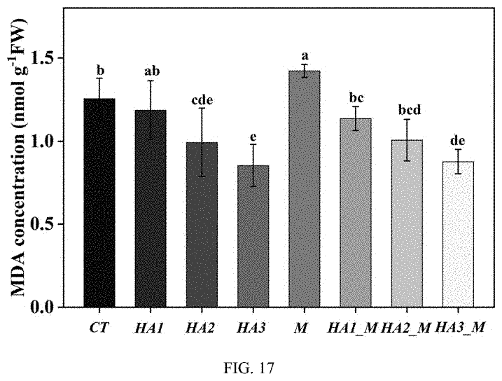

As shown in FIG. 17, the MDA concentration in the M group is significantly larger than that in the CT group (P<0.5), and in the groups without exogenous heavy metals treatment, the MDA concentration of Vallisneria natans leaves keeps decreasing with the increase of HA concentration compared to that of the CT group. In the groups treated with exogenous heavy metals, the MDA concentration of Vallisneria natans leaves keeps decreasing with the increase of HA concentration compared with that of the M group. Thus, it is speculated that the alleviating effect of HA on Vallisneria natans under Pb and Cd stresses increases with the increase of HA concentration. In summary, it is suggested that under heavy metal stress, HA increases the activity of SOD, POD and other enzymes related to reactive oxygen metabolism in plants by stimulating the synthesis of proteins and enzymes in various organs, and reduces the concentration in plants, regulates the reactive oxygen content in plants, reduces the degree of membrane lipid peroxidation, and enables plants to maintain a faster growth rate, and therefore maintains the osmotic properties of cell membranes and enhances the resistance of plants to heavy metals.

The positive role of HA on the growth of submerged plants is affected by HA concentration and plant species, etc. Through the above study, the following conclusions are drawn:
(1) the HA added has a positive effect on the growth of Vallisneria natans and may slow down the degreening of Vallisneria natans leaves under heavy metal toxic effects;
(2) HA increases the accumulation of Pb and Cd in the leaves and roots of Vallisneria natans plants while lowering the leaching capacity of heavy metals in the waterbody; and
(3) under heavy metal stress, HA enhances the resistance of plants to heavy metals by stimulating the synthesis of proteins and enzymes in various organs of plants, enhancing the activities of enzymes related to reactive oxygen metabolism such as SOD and POD in plants, and reducing the concentration of MDA in plants, regulating the content of reactive oxygen species in plants, and reducing the degree of membrane lipid peroxidation.

### IV. Effects of HA on Epigenetic Diversity of Vallisneria natans DNA under Heavy Metal Stress

4.1 Effects of HA, Pb and Cd Stresses on DNA Methylation of Vallisneria natans Leaves

The electrophoretic position of the PCR amplification product at a certain position of the same mobility of the gel with DNA bands is recorded as 1 and that without DNA bands is recorded as 0, which are then transformed into a data matrix of 0, 1, and the bands of DNA methylation types for each group of samples are counted and analyzed. As shown in Table 3, Vallisneria natans obtains a higher number of type I and IV bands with an average of 228.9 and 236.6 bands, respectively. The methylation status in the groups without exogenous heavy metals (CT, HA1, HA2, HA3 groups) are similar to each other, and the methylation status in the groups with exogenous heavy metals (M, HA1_M, HA2_M, HA3_M groups) are similar to each other, with significant differences in the types of hemi-methylation status (type II) of Vallisneria natans in the groups without and with exogenous heavy metals.

TABLE 2

| | Number of bands | | | | | | | |
|---|---|---|---|---|---|---|---|---|
| Types | CT | HA1 | HA2 | HA3 | M | HA1_M | HA2_M | HA3_M |
| I (1, 1) | 221 | 171 | 234 | 218 | 259 | 248 | 259 | 221 |
| II (1, 0) | 73 | 93 | 80 | 77 | 53 | 48 | 49 | 76 |
| III (0, 1) | 71 | 76 | 70 | 79 | 75 | 75 | 72 | 81 |
| IV (0, 0) | 244 | 269 | 225 | 235 | 222 | 238 | 229 | 231 |

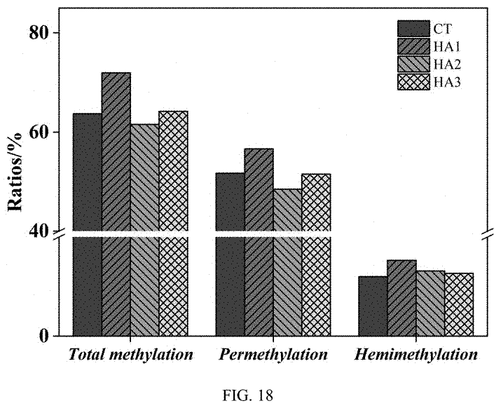

As shown in FIG. 18, the total methylation level, global methylation level and hemi-methylation level of Vallisneria natans leaves under HA1 condition are significantly higher compared with that of CT group, while the changes of total methylation level, global methylation level and hemi-methylation level under HA2 and HA3 conditions are not significant; it is deduced that the different concentrations of HA may have different degrees of effect on the methylation of Vallisneria natans leaves.

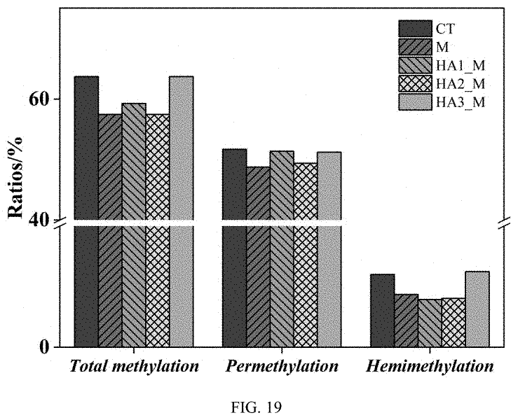

To further investigate the effect of HA on DNA methylation in Vallisneria natans leaves under Pb and Cd stresses, as shown in FIG. 19, the total methylation level, global methylation level and hemi-methylation level are significantly reduced in the M group compared with those in the CT group, especially the total methylation level, which is decreased from 63.71% to 57.47%. Previous studies have stated that environmental factors such as temperature, heavy metal and water stresses often lead to a decrease in DNA methylation levels in plant genomes and that DNA methylation can be involved in regulating the expression of detoxifying and transporting proteins for heavy metals, endowing plants with the ability to resist heavy metal toxicity. With the addition of different concentrations of HA, the total methylation level, global methylation level and hemi-methylation level show an increasing trend, especially in the HA3_M group, the total methylation level and hemi-methylation level are significantly increased, 1.1 and 1.4 times higher, respectively. Thus, it can be inferred that the addition of different concentrations of HA brings about different changes in DNA methylation levels in Vallisneria natans leaves under Pb and Cd stresses. A positive effect of HA on Vallisneria natans under heavy metal stress may be related to the expression of related genes caused by altered DNA methylation levels, as deduced from this analysis.

4.2 Changes of DNA Methylation in Vallisneria natans Leaves under HA, Pb and Cd Stresses
The results of MSAP methylation analysis as shown in Table 4 are of four types: Type I: both Hap II and Msp I have bands as (1, 1); Type II: Hap II has bands and Msp I has no bands as (1, 0); Type III: Hap II has no bands and Msp I has bands as (0, 1); Type IV: both Hap II and Msp I have no bands as (0, 0).

TABLE 4

| DNA | Enzymatic | | |
|---|---|---|---|
| methylation | cutting type | | |
| type | Hap II | Msp I | DNA methylation pattern |
| I | 1 | 1 | No methylation or hemi-methylation of |
| | | | medial cytosine |
| II | 1 | 0 | Extrinsic hemi-methylation of cytosine |
| III | 0 | 1 | Global methylation of medial cytosine |
| IV | 0 | 0 | Global methylation or sequence variation |
| | | | of medial and lateral cytosines |

The MSAP method is used to analyze the possible changes in methylation status of the genomic DNA of each group of Vallisneria natans leaves, and there are 15 types, of which types A, B, and C are all associated with methylation band types, while type D is a no-change band type, as shown in Table 5. Among the 5 methylation patterns of type A (re-methylation type, enhanced methylation), the highest ratio under Pb and Cd stresses (M group) is the control type I of treatment type IV (1, 1, 0, 0) with a ratio of 12.45%, and the lowest is the control type I of treatment type III (1, 1, 0, 1) with a ratio of 3.16%, with the CT group as the control. This data indicates that the DNA methylation of Vallisneria natans genome under Pb and Cd stresses is mainly in the pattern of no methylation or hemi-methylation of medial cytosine to global methylation of medial and lateral cytosines, with the least pattern of change from no methylation or hemi-methylation of medial cytosine to global methylation of medial cytosine. Among the 5 methylation patterns of type B (demethylation type with diminished methylation), the highest ratio in group M is control type IV of treatment type I (0, 0, 1, 1) with a ratio of 20.16%, and the lowest is control type IV of treatment type III (0, 0, 0, 1) with a ratio of 3.16%. This data suggests that the pattern of DNA methylation of Vallisneria natans genome under Pb and Cd stresses is dominated by the change from global methylation of inner and outer cytosines to no methylation or hemi-methylation of inner cytosines, and the least from global methylation of inner and outer cytosines to total methylation of inner cytosines. Furthermore, the ratio of DNA methylation patterns in each group of Vallisneria natans shows no significant correlation with HA concentrations as the HA concentration increases in the HA-only group. Among the types with remethylation, the ratios of control type I of treatment type IV (1, 1, 0, 0), control type I of treatment type III (1, 1, 0, 1) and control type III of treatment type IV (0, 1, 0, 0) are higher in the M group than the group with only HA; after adding different concentrations of HA, the ratios of control type I of treatment type IV (1, 1, 0, 0) in the HA_M group tend to increase, while the ratios of control type I of treatment type III (1, 1, 0, 1) and control type III of treatment type IV (0, 1, 0, 0) show a decreasing trend. Among the demethylation types, the ratio of control type IV of treatment type I (0, 0, 1, 1) in the M group is significantly higher than that in the HA-only group, and the ratio of control type IV of treatment type I (0, 0, 1, 1) in the HA_M group has a decreasing trend after adding different concentrations of HA, indicating that HA contributes to the types of demethylation in Vallisneria natans under heavy metal stress. The ratios of the two methylation patterns of type C (methylation indeterminate) are lower in each group. Among the three methylation patterns of type D (methylation indeterminate), the ratios of all three methylation indeterminate patterns in the HA and HA_M groups are greater than those in the M group, indicating that HA plays an important role in the maintenance of methylation in Vallisneria natans under heavy metal stress.

TABLE 5
Analysis of methylation pattern of Vallisneria natans leaves under 5 Pb and Cd stress

| | | Control | | Treatment | | | | | | | | |
|---|---|---|---|---|---|---|---|---|---|---|---|---|
| | Band | group | | group | | Ratio of different types in each group (%) | | | | | | |
| Type | type | H | M | H | M | HA1 | HA2 | HA3 | M | HA1_M | HA2_M | HA3_M |
| A | A1 | 1 | 1 | 1 | 0 | 8.73 | 3.84 | 4.04 | 3.16 | 3.49 | 3.04 | 4.61 |
| | A2 | 1 | 1 | 0 | 1 | 4.48 | 2.93 | 3.82 | 5.93 | 4.93 | 3.85 | 3.81 |
| | A3 | 1 | 1 | 0 | 0 | 10.85 | 6.77 | 9.21 | 12.45 | 12.73 | 12.96 | 13.03 |
| | A4 | 1 | 0 | 0 | 0 | 7.08 | 4.74 | 4.27 | 6.72 | 8.83 | 7.09 | 8.02 |
| | A5 | 0 | 1 | 0 | 0 | 1.89 | 1.81 | 2.47 | 4.35 | 3.29 | 3.04 | 3.21 |
| B | B1 | 1 | 0 | 1 | 1 | 3.54 | 6.09 | 5.84 | 4.94 | 3.70 | 3.64 | 3.01 |
| | B2 | 0 | 1 | 1 | 1 | 4.25 | 4.06 | 3.37 | 3.95 | 3.90 | 4.05 | 3.61 |
| | B3 | 0 | 0 | 1 | 1 | 4.48 | 6.32 | 7.19 | 20.16 | 19.10 | 19.84 | 14.83 |
| | B4 | 0 | 0 | 1 | 0 | 5.42 | 8.35 | 6.52 | 5.14 | 3.49 | 3.24 | 6.81 |
| | B5 | 0 | 0 | 0 | 1 | 4.01 | 2.93 | 4.27 | 2.57 | 3.49 | 3.04 | 5.21 |
| C | C1 | 1 | 0 | 0 | 1 | 0.24 | 0.68 | 0.90 | 0.99 | 0.62 | 0.81 | 1.40 |
| | C2 | 0 | 1 | 1 | 0 | 1.42 | 0.90 | 1.35 | 0.40 | 0.00 | 0.40 | 1.60 |
| D | D1 | 1 | 1 | 1 | 1 | 28.07 | 36.34 | 32.58 | 22.13 | 24.23 | 24.90 | 22.85 |
| | D2 | 1 | 0 | 1 | 0 | 6.37 | 4.97 | 5.39 | 1.78 | 1.85 | 3.24 | 2.20 |
| | D3 | 0 | 1 | 0 | 1 | 9.20 | 9.26 | 8.76 | 5.34 | 6.37 | 6.88 | 5.81 |

Plants under external environmental stress produce epigenetic variation, and DNA methylation, which regulates plant growth and development without altering genome sequence, is a primary mode of epigenetic action. There are mainly two modes of regulating gene expression in plants: remethylation and demethylation. These are the ways by which plants protect themselves against external environmental stresses. The process of remethylation is thought to be associated with genomic imprinting, transcriptional regulatory genes, etc., which regulates plant growth and development and plays an important role in genomic defense; while the process of demethylation is thought to influence life activities such as chromosome activity, embryonic growth, cell differentiation and carcinogenesis in favor of gene expression. Studies show that the alteration of plant DNA methylation patterns under heavy metal stress is mainly characterized by the occurrence of remethylation, and further suggest that genomic DNA may disable the expression of certain related genes and inhibit transcription through methylation, thus reducing the toxicity of heavy metals and enhancing the adaptation of plants to heavy metal stress. In contrast, the addition of HA in this study alters the ratios of some remethylation and demethylation types and increases the ratios of maintenance methylation types in Vallisneria natans under heavy metal stress, suggesting that the positive effect of HA on the response of Vallisneria natans to heavy metal stress is probably through modifying the remethylation and demethylation types and increasing the maintenance methylation types to regulate its gene expression, thus enhancing the adaptation and tolerance of Vallisneria natans to heavy metal stress.

The above-mentioned embodiments only describe the preferred mode of the present application, but do not limit the scope of the present application. On the premise of not departing from the design spirit of the present application, all kinds of modifications and improvements made by ordinary technicians in the field to the technical scheme of the application shall fall within the scope of protection determined by the claims of the present application.

What is claimed is:

1. Application of humic acid (HA) in improving phytoremediation efficiency of heavy metals in waterbody, comprising reducing heavy metals in terms of content in the waterbody by planting Vallisneria natans to achieve phytoremediation of heavy metals.

2. The application according to claim 1, wherein the application comprises alleviating a degreening phenomenon of Vallisneria natans leaves under heavy metal toxicity.

3. The application according to claim 1, wherein the application comprises increasing accumulation of heavy metals in leaves and roots of Vallisneria natans.

4. The applications according to claim 1, wherein the application comprises reducing leaching capacity of the heavy metals in the waterbody.

5. The application according to claim 1, wherein the application comprises improving the Vallisneria natans in terms of resistance to the heavy metals.

6. A method of using HA to improve remediation efficiency of Vallisneria natans against heavy metals in waterbody, comprising adding HA into the waterbody, wherein the HA is in a concentration of 0.5-2 micrograms per liter (mg·L⁻¹) in the waterbody.
